(19) United States
(12) Patent Application Publication
(10) Pub. No.: US 2022/0186112 A1
(43) Pub. Date: Jun. 16, 2022

(54) HIGH QUANTUM DOT DISPERSION COMPOSITION, OPTICAL FILM, AND BACKLIGHT MODULE

(71) Applicant: NAN YA PLASTICS CORPORATION, TAIPEI (TW)

(72) Inventors: TE-CHAO LIAO, TAIPEI (TW); CHUN-CHE TSAO, TAIPEI (TW); Ren-Yu Liao, New Taipei City (TW)

(21) Appl. No.: 17/340,106

(22) Filed: Jun. 7, 2021

(30) Foreign Application Priority Data
Dec. 11, 2020 (TW) 109143820

(51) Int. Cl. C09K 11/02; C08J 5/18; C08L 35/02; F21V 8/00

(52) U.S. Cl. CPC C09K 11/025; C08J 5/18; B82Y 20/00; G02B 6/0026; C08L 35/02

(57) ABSTRACT

A high quantum dot dispersion composition, an optical film, and a backlight module are provided. The high quantum dot dispersion composition includes 1 to 5 wt % of photoinitiator, 3 to 20 wt % of scattering particles, 15 to 50 wt % of thiol compound, 5 to 30 wt % of monofunctional acrylic monomer, 20 to 40 wt % of multifunctional acrylic monomer, 1 to 5 wt % of organosilicon grafted oligomer and 500 to 1500 ppm of inhibitor.

### CROSS-REFERENCE TO RELATED PATENT APPLICATION

This application claims the benefit of priority to Taiwan Patent Application No. 109143820, filed on Dec. 11, 2020. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a high quantum dot dispersion composition, an optical film and a backlight module, and more particularly to a high quantum dot dispersion composition capable of being applied in a backlight module and an LED package.

### BACKGROUND OF THE DISCLOSURE

In recent years, with the development of display technology, people have higher expectations for the quality of displays. Quantum dots (QDs) have attracted wide attention from researchers due to their unique quantum confinement effects. Compared with conventional organic light-emitting materials, the luminous efficacy of the quantum dots has the advantages of having a narrow full width at half maximum (FWHM), small particles, no scattering loss, a spectrum that is adjustable with size, and a stable photochemical performance. In addition, optical, electrical, and transmission properties of the quantum dots can be adjusted through a synthesis process. Such advantages have contributed to the importance of quantum dot technology, and polymer composite materials with quantum dots have been used in fields such as backlights and display devices in recent years.

However, the luminous efficiency of the quantum dots is highly susceptible to oxygen, water vapor, etc. In addition, a manufacturing method of a quantum dot gel layer is required to take dispersion of quantum dots and a polymerization effect into consideration. Therefore, how to overcome the above-mentioned problems by improving formulation of the quantum dot gel layer, so as to have better quantum dot dispersion and better blockage of water vapor and oxygen, has become one of the important issues to be solved in this field.

### SUMMARY OF THE DISCLOSURE

In response to the above-referenced technical inadequacies, the present disclosure provides a high quantum dot dispersion composition, and an optical film and a backlight module manufactured from the high quantum dot dispersion composition.

In one aspect, the present disclosure provides a high quantum dot dispersion composition, which is used for manufacturing a quantum dot gel layer. More specifically, the high quantum dot dispersion composition includes 1 to 5 wt % of photoinitiator, 3 to 20 wt % of scattering particles, 15 to 50 wt % of thiol compound, 5 to 30 wt % of monofunctional acrylic monomer, 20 to 40 wt % of multifunctional acrylic monomer, 1 to 5 wt % of organosilicon grafted oligomer, and 500 to 1500 ppm of inhibitor.

In certain embodiments, the high quantum dot dispersion composition further includes a plurality of quantum dots dispersed in the high quantum dot dispersion composition, in which the plurality of quantum dots is modified by a surface modifying material, and the surface modifying material has functional groups selected from a group consisting of R₃P, R₃PO, RNH₂, RCOOH, RSH and RPO₃H₂, where R is a linear or branched long-chain alkyl, aryl, arylalkyl or alkaryl group.

In certain embodiments, the thiol compound is a primary thiol compound or a secondary thiol compound, and is selected from a group consisting of 2, 2′-(ethylenedioxy)diethyl mercaptan, 2, 2′-thiodiethanethiol, trimethylolpropane tris(3-mercaptopropionate), poly(ethylene glycol) dithiol, pentaerythritol tetrakis (3-mercaptopropionate), ethylene glycol bis-mercaptoacetate, and ethyl 2-mercaptopropionate.

In certain embodiments, the monofunctional acrylic monomer is selected from a group consisting of tetrahydrofurfuryl methacrylate, stearyl acrylate, lauryl methacrylate, lauryl acrylate, isobornyl methacrylate, tridecyl acrylate, alkoxylated nonylphenol acrylate, tetraethylene glycol dimethacrylate, polyethylene glycol (600) dimethacrylate, tripropylene glycol diacrylate and ethoxylated (10) bisphenol A dimethacrylate.

In certain embodiments, the multifunctional acrylic monomer is selected from a group consisting of trimethylolpropane triacrylate, trimethylolpropane trimethacrylate, ethoxylated (20) trimethylolpropane triacrylate, and pentaerythritol triacrylate.

In certain embodiments, the organosilicon grafted oligomer is selected from a group consisting of silicone acrylate and silicone epoxy resin.

In certain embodiments, the inhibitor is selected from a group consisting of pyrogallol (PYR), hydroquinone, catechol, potassium iodide-iodine mixtures, hindered phenolics, aluminum/ammonium cupferronate salts (N-nitrosophenyl hydroxylamine ammonium salt/N-nitroso-N-phenylhydroxylamine aluminum salt), 3-propenylphenol triaryl phosphines, triaryl phosphines, triaryl phosphites, phosphonic acid, and a combination of an alkenyl-phenol and cupferronate salt.

In another aspect, the present disclosure provides an optical film, which includes: a quantum dot gel layer and a first shielding layer. The quantum dot gel layer has a first side and a second side opposite to the first side, the first shielding layer has a chemically treated surface, and the first shielding layer is disposed on the quantum dot gel layer by the chemically treated surface. The quantum dot gel layer includes a high quantum dot dispersion composition and a plurality of quantum dots dispersed in the high quantum dot dispersion composition, and the high quantum dot dispersion composition includes: 1 to 5 wt % of photoinitiator, 3 to 20 wt % of scattering particles, 15 to 50 wt % of thiol compound, 5 to 30 wt % of monofunctional acrylic monomer, 20 to 40 wt % of multifunctional acrylic monomer, 1 to 5 wt % of organosilicon grafted oligomer, and 500 to 1500 ppm of inhibitor.

In certain embodiments, the optical film further includes a second shielding layer having a chemically treated surface, and the second shielding layer is disposed on the quantum dot gel layer by the chemically treated surface.

In yet another aspect, the present disclosure provides a backlight module, which includes: a light guide unit, at least one light emitting unit and an optical unit. The optical unit corresponds to the light entrance side, and is disposed between the light guide unit and the at least one light emitting unit. Specifically, the optical unit includes a quantum dot gel layer and a first shielding layer, in which the quantum dot gel layer includes a high quantum dot dispersion composition and a plurality of quantum dots dispersed in the high quantum dot dispersion composition. The high quantum dot dispersion composition includes: 1 to 5 wt % of photoinitiator, 3 to 20 wt % of scattering particles, 15 to 50 wt % of thiol compound, 5 to 30 wt % of monofunctional acrylic monomer, 20 to 40 wt % of multifunctional acrylic monomer, 1 to 5 wt % of organosilicon grafted oligomer; and 500 to 1500 ppm of inhibitor.

In certain embodiments, the backlight module further includes a second shielding layer, disposed on the second side of the quantum dot gel layer.

Therefore, by virtue of “the quantum dot gel layer including a high quantum dot dispersion composition and a plurality of quantum dots dispersed in the high quantum dot dispersion composition” and “the high quantum dot dispersion composition including: 1 to 5 wt % of photoinitiator, 3 to 20 wt % of scattering particles, 15 to 50 wt % of thiol compound, 5 to 30 wt % of monofunctional acrylic monomer, 20 to 40 wt % of multifunctional acrylic monomer, 1 to 5 wt % of organosilicon grafted oligomer; and 500 to 1500 ppm of inhibitor”, the high quantum dot dispersion composition of the present disclosure provides better quantum dots dispersion, so that said composition can be applied to different types of optical films and backlight modules.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1A is a sectional view of an optical film according to a first embodiment of the present disclosure;

FIG. 1B is a sectional view of another optical film according to the first embodiment of the present disclosure;

FIG. 2A is a sectional view of an optical film according to a second embodiment of the present disclosure;

FIG. 2B is a sectional view of another optical film according to the second embodiment of the present disclosure; and

FIG. 3 shows a sectional view of a backlight module according to one embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way.

Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

An embodiment of the present disclosure provides a high quantum dot dispersion composition, which includes: 1 to 5 wt % of photoinitiator, 3 to 20 wt % of scattering particles, 15 to 50 wt % of thiol compound, 5 to 30 wt % of monofunctional acrylic monomer, 20 to 40 wt % of multifunctional acrylic monomer, 1 to 5 wt % of organosilicon grafted oligomer; and 500 to 1500 ppm of inhibitor.

Moreover, the high quantum dot dispersion composition further includes a plurality of surface modified quantum dots dispersed in the high quantum dot dispersion composition, in which the quantum dots include red quantum dots, green quantum dots, blue quantum dots or a combination thereof. For example, the quantum dots may be a combination of the red quantum dots and the green quantum dots. Each of the quantum dots has a different or a same particle size. In addition, each of the quantum dots includes a core and a shell, and the shell covers the core.

In one or more embodiments, the material of the core/shell of the quantum dots may include cadmium selenide (CdSe)/zinc sulfide (ZnS), indium phosphide (InP)/zinc sulfide (ZnS), lead selenide (PbSe)/lead sulfide (PbS), cadmium selenide (CdSe)/cadmium sulfide (CdS), cadmium telluride (CdTe)/cadmium sulfide (CdS) or cadmium telluride (CdTe)/zinc sulfide (ZnS). However, these embodiments are not meant to limit the scope of the present disclosure.

Furthermore, a surface modifying material has functional groups selected from a group consisting of R₃P, R₃PO, RNH₂, RCOOH, RSH and RPO₃H₂, where R is a linear or branched long-chain alkyl, aryl, arylalkyl or alkaryl group. For example, the surface modifying material can be tertiary phosphine compounds, such as trioctyl phosphine, triphenyl phosphine, tertiary butyl phosphine, etc.; phosphine oxides, such as trioctyl phosphine oxide and triphenyl phosphine oxide; alkyl phosphonic acids and alkyl amines, such as hexadecyl amine, octyl amine, etc.; aryl amines, pyridines, long-chain fatty acids, thiophenes, etc.

Moreover, both the core and the shell of the quantum dots can be composite materials in Group II-VI, Group II-V, Group III-VI, Group III-V, Group IV-VI, Group II-IV-VI or Group II-IV-V, where the term “group” refers to an element group of the periodic table.

Specifically, the material of the core can be zinc sulfide (ZnS), zinc selenide (ZnSe), zinc telluride (ZnTe), cadmium sulfide (CdS), cadmium selenide (CdSe), cadmium telluride (CdTe), mercury sulfide (HgS), mercury selenide (HgSe), mercury telluride (HgTe), aluminum nitride (AlN), aluminum phosphide (AlP), aluminum arsenide (AlAs), aluminum antimonide (AlSb), gallium nitride (GaN), gallium phosphide (GaP), gallium arsenide (GaAs), gallium antimonide (GaSb), gallium selenide (GaSe), indium nitride (InN), indium phosphide (InP), indium arsenide (InAs), indium antimonide (InSb), thallium nitride (TlN), thallium phosphide (TlP), thallium arsenide (TlAs), thallium antimonide (TlSb), lead sulfide (PbS), lead selenide (PbSe), lead telluride (PbTe) or any combination of the above.

The material of the shell can be zinc oxide (ZnO), zinc sulfide (ZnS), zinc selenide (ZnSe), zinc telluride (ZnTe), cadmium oxide (CdO), cadmium sulfide (CdS), cadmium selenide (CdSe), cadmium telluride (CdTe), magnesium oxide (MgO), magnesium sulfide (MgS), magnesium selenide (MgSe), magnesium telluride (MgTe), mercury oxide (HgO), mercury sulfide (HgS), mercury selenide (HgSe), mercury telluride (HgTe), aluminum nitride (AlN), aluminum phosphide (AlP), aluminum arsenide (AlAs), aluminum antimonide (AlSb), gallium nitride (GaN), gallium phosphide (GaP), gallium arsenide (GaAs), gallium antimonide (GaSb), indium nitride (InN), indium phosphide (InP), indium arsenide (InAs), indium antimonide (InSb), thallium nitride (TlN), thallium phosphide (TlP), thallium arsenide (TlAs), thallium antimonide (TlSb), lead sulfide (PbS), lead selenide (PbSe), lead telluride (PbTe) or any combination of the above.

Further, a composition ratio of a quantum dot gel layer is provided in a first embodiment of the present disclosure. The quantum dot gel layer includes the high quantum dot dispersion composition and a plurality of the quantum dots dispersed in the high quantum dot dispersion composition. Specifically, the quantum dot gel layer includes 0.1 to 5 wt % of quantum dot inorganic materials. Based on a total weight of the quantum dot gel layer being 100 weight percent, the high quantum dot dispersion composition includes 1 to 5 wt % of photoinitiator, 3 to 20 wt % of scattering particles, 15 to 50 wt % of thiol compound, 5 to 30 wt % of monofunctional acrylic monomer, 20 to 40 wt % of multifunctional acrylic monomer, 1 to 5 wt % of organosilicon grafted oligomer, and 500 to 1500 ppm of inhibitor. It should be noted that based on the total weight of the quantum dot gel layer being 100 weight percent, a total weight of a mixture of the photoinitiator, the scattering particles, the thiol compound, the monofunctional acrylic monomer, the multifunctional acrylic monomer and the organosilicon grafted oligomer is 100% by weight, and then 500 to 1500 ppm of the inhibitor is added.

The photoinitiator is selected from a group consisting of 1-hydroxycyclohexyl phenyl ketone, benzoyl isopropanol, tribromomethyl benzene sulfide and diphenyl (2, 4, 6-trimethylbenzoyl) phosphine oxide. The scattering particles are surface-treated acrylic or silicon dioxide or polystyrene beads, and have a particle size ranging from 0.5 to 20 μm. However, curing of the gel layer is difficult when the content of the photoinitiator is less than 1 wt %, and the volatility of the overall properties of the gel layer is affected when the content of the photoinitiator is more than 5 wt %.

The scattering particles are surface-treated microbeads, and have a particle size ranging from 0.5 to 10 μm. The material of the microbeads can be acrylic, silicon dioxide, germanium dioxide, titanium dioxide, zirconium dioxide, aluminum oxide or polystyrene. A refractive index of the scattering particles is about 1.39 to 1.45. The scattering particles provide better light scattering for the quantum dots, so that the light passing through the quantum dot gel layer is more uniform. When the content of the scattering particles is less than 3 wt %, the haze will be insufficient. When the content of the scattering particles exceeds 20 wt %, the haze will be too much, which results in insufficiency of resin contained in the overall material, affects dispersibility, and increases processing difficulty.

Specifically, the thiol compound is selected from a group consisting of 2, 2′-(ethylenedioxy)diethyl mercaptan, 2,2′-thiodiethanethiol, trimethylolpropane tris(3-mercaptopropionate), poly(ethylene glycol) dithiol, pentaerythritol tetrakis (3-mercaptopropionate), ethylene glycol bis-mercaptoacetate, and ethyl 2-mercaptopropionate. The thiol compound is a non-aromatic compound containing a sulfhydryl functional group (—SH), which provides a functional group that can form a better bond with the quantum dot, so that the quantum dot has better dispersibility. The content of the thiol compound is higher in comparison to that of the conventional art, so as to have a higher degree of polymerization. However, no effect can be achieved when the content of the thiol compound is less than 20 wt %, and the gel layer becomes too soft and easily bent when the content of the thiol compound exceeds 50 wt %.

The monofunctional acrylic monomer is selected from a group consisting of tetrahydrofurfuryl methacrylate, stearyl acrylate, lauryl methacrylate, lauryl acrylate, isobornyl methacrylate, tridecyl acrylate, alkoxylated nonylphenol acrylate, tetraethylene glycol dimethacrylate, polyethylene glycol (600) dimethacrylate, tripropylene glycol diacrylate and ethoxylated (10) bisphenol A dimethacrylate. When the content of the monofunctional acrylic monomer is too low, the quantum dots have poor dispersibility. However, when the content of the monofunctional acrylic monomer is too much, the quantum dots may have low polymerization efficiency and poor weather resistance.

The multifunctional acrylic monomer is selected from a group consisting of trimethylolpropane triacrylate, trimethylolpropane trimethacrylate, ethoxylated (20) trimethylolpropane triacrylate, and pentaerythritol triacrylate. The multifunctional acrylic monomer not only allows polymerization to accelerate but enhances graft density and the effect of blocking water vapor and oxygen. However, when the multifunctional acrylic monomer is added in an excessive amount, the gel layer may become too brittle and prone to breakage.

A molecular weight of the organosilicon grafted oligomer is about 4000 to 30,000, and a protection effect is provided to the quantum dots through groups having larger molecular weight. The organosilicon grafted oligomer is selected from the group consisting of silicone acrylate and silicone epoxy resin. The organosilicon grafted oligomer can increase the weather resistance of the polymer, and also improve the mechanical strength of the polymer. Generally, in the conventional art, if a shielding layer is omitted in an optical film, not only will the effect of water vapor and oxygen resistance be reduced, but the problem of insufficient mechanical strength will also occur. Therefore, in the present disclosure, 1 to 5 wt % of the organosilicon grafted oligomer can improve the mechanical strength of the quantum dot gel layer. When the amount of the organosilicon grafted oligomer is greater than 1 to 5 wt %, the dispersibility and processability may be affected, and the cost may be increased.

The inhibitor is selected from a group consisting of pyrogallol (PYR), hydroquinone, catechol, potassium iodide-iodine mixtures, hindered phenolics, aluminum/ammonium cupferronate salts (N-nitrosophenyl hydroxylamine ammonium salt/N-nitroso-N-phenylhydroxylamine aluminum salt), 3-propenylphenol triaryl phosphines, triaryl phosphines, triaryl phosphites, phosphonic acid, and a combination of an alkenyl-phenol and cupferronate salt. The inhibitor can effectively slow down the reaction rate and prevent the formula in the composition from having a mutual influence. For example, the thiol compound and multifunctional acrylic monomer are prone to self-react at room temperature. The addition of the inhibitor during manufacturing allows for better processability and a more stable preservation. However, the suppression effect cannot be achieved when an added amount of the inhibitor is less than 500 ppm, and the photocuring efficiency can be affected when the added amount of the inhibitor is more than 1500 ppm.

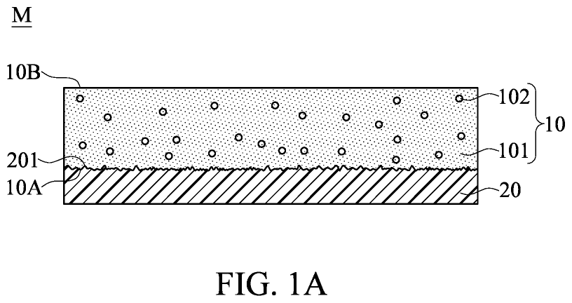

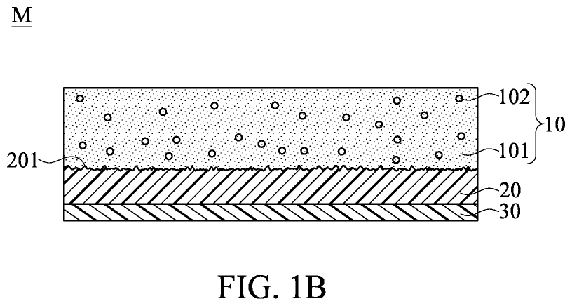

Reference is made to FIGS. 1A and 1B, which show a first embodiment of an optical film M of the present disclosure. As shown in FIG. 1A, the optical film M of the present disclosure includes: a quantum dot gel layer 10, and a first shielding layer 20 disposed on the quantum dot gel layer 10. Specifically speaking, the quantum dot gel layer 10 includes a high quantum dot dispersion composition 101 and a plurality of quantum dots 102 dispersing in the high quantum dot dispersion composition 101. Further, the quantum dot gel layer 10 has a first side 10A and a second side 10B, the first shielding layer 20 includes a chemically treated surface 201, and the first shielding layer 20 is disposed on the first side 10A of the quantum dot gel layer 10 by the chemically treated surface 201, and the second side 10B of the quantum dot gel layer 10 is not covered.

Referring to FIG. 1B, the optical film of the present disclosure further includes a first matte treated layer 30 disposed on the first shielding layer 20, so that the first shielding layer 20 is arranged between the quantum dot gel layer 10 and the matte treated layer 30.

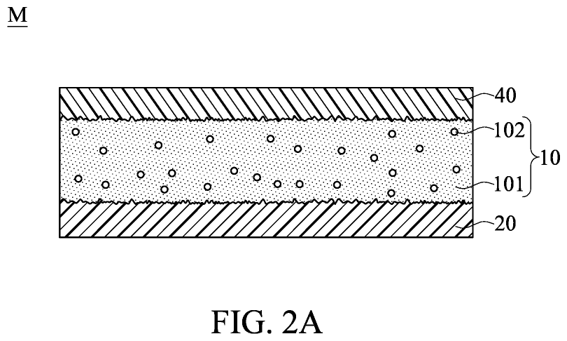

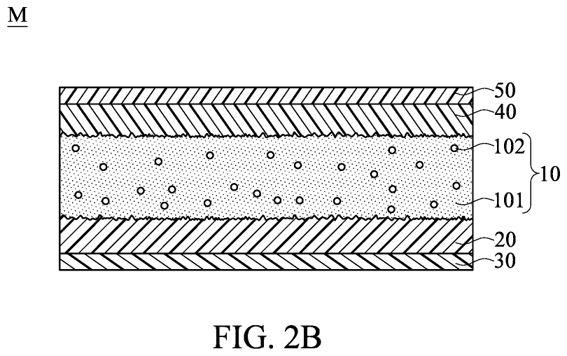

Reference is made to FIGS. 2A and 2B, which show a second embodiment of the optical film of the present disclosure. As shown in FIG. 2A, the optical film M of the present disclosure includes: a quantum dot gel layer 10, a first shielding layer 20, and a second shielding layer 40. The quantum dot gel layer 10 has a first side 10A and a second side 10B. Further, the first shielding layer 20 includes a chemically treated surface 201, and the first shielding layer 20 is disposed on the first side 10A of the quantum dot gel layer 10 by the chemically treated surface 201. The second shielding layer 40 includes a chemically treated surface 401, and the second shielding layer 40 is disposed on the second side 10B of the quantum dot gel layer 10 by the chemically treated surface 401. That is to say, both sides of the quantum dot gel layer 10 (i.e., the first side 10A and the second side 10B) are covered by the shielding layers.

Moreover, referring to FIG. 2B, the optical film M of the present disclosure further includes a first matte treated layer 30 and a second matte treated layer 50. The first matte treated layer 30 is disposed on the first shielding layer 20, so that the first shielding layer 20 is arranged between the quantum dot gel layer 10 and the first matte treated layer 30. The second matte treated layer 50 is disposed on the second shielding layer 40, so that the second shielding layer 40 is arranged between the quantum dot gel layer 10 and the second matte treated layer 50.

Specifically, a thickness of the quantum dot gel layer 10 is about 30 to 50 μm, a thickness of the first shielding layer 20 or the second shielding layer 40 is about 20 to 30 μm, and a thickness of the first matte treated layer 30 or the second matte treated layer 50 is about 3 to 5 μm.

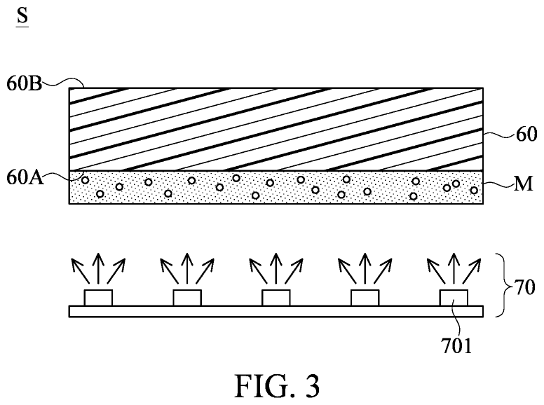

Referring to FIG. 3, the present disclosure further provides a backlight module S, which includes: a light guide unit 60, at least one light emitting unit 70 and an optical film M (an optical unit). The light guide unit 60 has a light incident side 60A, and the at least one light emitting unit 70 corresponds to the light incident side 30A, and has a plurality of light emitting units. The optical film M is opposite to the light incident side 60A, and the optical film M is located between the light guide unit 60 and the at least one light emitting unit 70. In detail, the light guide unit 60 has a light incident side 60A and a light emitting side 60B that are opposite to each other, and the optical film M is disposed on the light incident side 60A. More specifically, the optical film M is the above-mentioned optical film of the present disclosure. However, the aforementioned description is merely an example and is not meant to limit the scope of the present disclosure.

In other embodiments, the present disclosure further provides a manufacturing method of the optical film, which includes: dispersing a plurality of modified quantum dots in the monofunctional acrylic monomer, adding the inhibitor, then adding the thiol compound, then further adding the multifunctional acrylic monomer, and finally adding the photoinitiator, the scattering particles, and the organosilicon grafted oligomer.

In addition to the foregoing steps, the manufacturing method of the optical film of the present disclosure further includes: performing a cutting process to cut the optical film into a required size; and performing a winding process to wind the rest of the optical film into a roll for use or storage.

### Embodiments

As shown in Table 1, the quantum dot gel layers of embodiments 1-3 and comparative embodiment 1 are manufactured according to the following formula and ratio, and are further tested for their dispersibility. In detail, the following ratio is based on a total weight of the quantum dot gel layer being 100 weight percent, in which the total weight of the photoinitiator, the scattering particles, the thiol compound, the monofunctional acrylic monomer, the multifunctional acrylic monomer and the organosilicon grafted oligomer is 100 weight percent, and the inhibitor is then added.

Specifically, the detailed steps are as follows: firstly, dispersing a plurality of the quantum dots in the monofunctional acrylic monomer to form a quantum dots-monofunctional acrylic monomer solvent; adding the inhibitor to the quantum dots-monofunctional acrylic monomer solvent and having the inhibitor and the quantum dots-monofunctional acrylic monomer solvent mixed uniformly; and sequentially adding the thiol compound, then the multifunctional acrylic monomer, and finally the photoinitiator, the scattering particles, and the organosilicon grafted oligomer, which are mixed uniformly.

TABLE 1

| | | | | | | | Comparative | |
|---|---|---|---|---|---|---|---|---|
| Formula | Embodiment 1 | | Embodiment 2 | | Embodiment 3 | | embodiment 1 | |
| Photoinitiator | 3 | wt % | 3 | wt % | 3 | wt % | 3 | wt % |
| Scattering particles | 7 | wt % | 4 | wt % | 3 | wt % | 7 | wt % |
| Thiol compound | 15 | wt % | 20 | wt % | 25 | wt % | 0 | wt % |
| Monofunctional acrylic | 30 | wt % | 25 | wt % | 16 | wt % | 30 | wt % |
| monomer | | | | | | | | |
| Multifunctional acrylic | 20 | wt % | 20 | wt % | 20 | wt % | 40 | wt % |
| monomer | | | | | | | | |
| Organosilicon grafted | 5 | wt % | 3 | wt % | 3 | wt % | 5 | wt % |
| oligomer | | | | | | | | |
| Inhibitor | 1000 | ppm | 1000 | ppm | 1000 | ppm | 0 | |
| Quantum dots | 20 | wt % | 25 | wt % | 30 | wt % | 15 | wt % |

The “Quantum dots” refers to the dispersibility of the quantum dots dispersing in the composition.

### Beneficial Effects of the Embodiments

In conclusion, by virtue of “the quantum dot gel layer including a high quantum dot dispersion composition and a plurality of quantum dots dispersed in the high quantum dot dispersion composition” and “the high quantum dot dispersion composition including: 1 to 5 wt % of photoinitiator, 3 to 20 wt % of scattering particles, 15 to 50 wt % of thiol compound, 5 to 30 wt % of monofunctional acrylic monomer, 20 to 40 wt % of multifunctional acrylic monomer, 1 to 5 wt % of organosilicon grafted oligomer; and 500 to 1500 ppm of inhibitor”, the high quantum dot dispersion composition of the present disclosure provides at least 20 wt % quantum dots dispersing in the composition, so that said composition can be applied to different types of optical films and backlight modules.

Further, the quantum dots can be initially diluted by use of the monofunctional acrylic monomer, and according to the specific sequence of addition provided in the present disclosure, the manufacturing efficiency can be effectively improved. In addition, the thiol compound is a non-aromatic compound containing a sulfhydryl functional group (—SH), which forms a better bond with the quantum dot, so that the quantum dots have better dispersibility. Compared with the conventional art, the ratio of the thiol compound is higher, which also results in a higher degree of polymerization.

More specifically, the high quantum dot dispersion composition of the present disclosure is suitable for quantum dots modified by a specific surface modifying material. Preferably, the surface modifying material has functional groups selected from a group consisting of R₃P, R₃PO, RNH₂, RCOOH, RSH and RPO₃H₂, where R is a linear or branched long-chain alkyl, aryl, arylalkyl or alkaryl group.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A high quantum dot dispersion composition, the high quantum dot dispersion composition, based on a total weight thereof, comprising:
1 to 5 wt % of photoinitiator;
3 to 20 wt % of scattering particles;
15 to 50 wt % of thiol compound;
5 to 30 wt % of monofunctional acrylic monomer;
20 to 40 wt % of multifunctional acrylic monomer;
1 to 5 wt % of organosilicon grafted oligomer; and
500 to 1500 ppm of inhibitor.

2. The high quantum dot dispersion composition according to claim 1, further comprising: a plurality of quantum dots dispersed in the high quantum dot dispersion composition, wherein the plurality of quantum dots is modified by a surface modifying material, and the surface modifying material has functional groups selected from a group consisting of R₃P, R₃PO, RNH₂, RCOOH, RSH and RPO₃H₂, where R is a linear or branched long-chain alkyl, aryl, arylalkyl or alkaryl group.

3. The high quantum dot dispersion composition according to claim 1, wherein the thiol compound is a primary thiol compound or a secondary thiol compound, and is selected from a group consisting of 2, 2′-(ethylenedioxy)diethyl mercaptan, 2,2′-thiodiethanethiol, trimethylolpropane tris(3-mercaptopropionate), poly(ethylene glycol) dithiol, pentaerythritol tetrakis (3-mercaptopropionate), ethylene glycol bis-mercaptoacetate, and ethyl 2-mercaptopropionate.

4. The high quantum dot dispersion composition according to claim 1, wherein the monofunctional acrylic monomer is selected from a group consisting of tetrahydrofurfuryl methacrylate, stearyl acrylate, lauryl methacrylate, lauryl acrylate, isobornyl methacrylate, tridecyl acrylate, alkoxylated nonylphenol acrylate, tetraethylene glycol dimethacrylate, polyethylene glycol (600) dimethacrylate, tripropylene glycol diacrylate and ethoxylated (10) bisphenol A dimethacrylate.

5. The high quantum dot dispersion composition according to claim 1, wherein the multifunctional acrylic monomer is selected from a group consisting of trimethylolpropane triacrylate, trimethylolpropane trimethacrylate, ethoxylated (20) trimethylolpropane triacrylate, and pentaerythritol triacrylate.

6. The high quantum dot dispersion composition according to claim 1, wherein the organosilicon grafted oligomer is selected from a group consisting of silicone acrylate and silicone epoxy resin.

7. The high quantum dot dispersion composition according to claim 1, wherein the inhibitor is selected from a group consisting of pyrogallol (PYR), hydroquinone, catechol, potassium iodide-iodine mixtures, hindered phenolics, aluminum/ammonium cupferronate salts (N-nitrosophenyl hydroxylamine ammonium salt/N-nitroso-N-phenylhydroxylamine aluminum salt), 3-propenylphenol triaryl phosphines, triaryl phosphines, triaryl phosphites, phosphonic acid, and a combination of an alkenyl-phenol and cupferronate salt.

8. An optical film, comprising:
a quantum dot gel layer having a first side and a second side opposite to the first side; and
a first shielding layer having a chemically treated surface, the first shielding layer being disposed on the first side of the quantum dot gel layer through the chemically treated surface;
wherein the quantum dot gel layer includes a high quantum dot dispersion composition and a plurality of quantum dots dispersed in the high quantum dot dispersion composition;
wherein the high quantum dot dispersion composition includes:
1 to 5 wt % of photoinitiator;
3 to 20 wt % of scattering particles;
15 to 50 wt % of thiol compound;
5 to 30 wt % of monofunctional acrylic monomer;
20 to 40 wt % of multifunctional acrylic monomer;
1 to 5 wt % of organosilicon grafted oligomer; and
500 to 1500 ppm of inhibitor.

9. The optical film according to claim 8, further comprising:
a second shielding layer having a chemical treated surface, the second shielding layer being disposed on the second side of the quantum dot gel layer through the chemically treated surface.

10. A backlight module, comprising:
a light guide unit having a light entrance side;
at least one light emitting unit corresponding to the light entrance side; and
an optical unit corresponding to the light entrance side and disposed between the light guide unit and the at least one light emitting unit, the optical unit including:
a quantum dot gel layer having a first side and a second side; and
a first shielding layer disposed on the first side of the quantum dot gel layer;
wherein the quantum dot gel layer includes a high quantum dot dispersion composition and a plurality of quantum dots dispersed in the high quantum dot dispersion composition, and the high quantum dot dispersion composition, based on a total weight thereof, includes:
1 to 5 wt % of photoinitiator;
3 to 20 wt % of scattering particles;
15 to 50 wt % of thiol compound;
5 to 30 wt % of monofunctional acrylic monomer;
20 to 40 wt % of multifunctional acrylic monomer;
1 to 5 wt % of organosilicon grafted oligomer; and
500 to 1500 ppm of inhibitor.

11. The backlight module according to claim 10, further comprising:
a second shielding layer disposed on the second side of the quantum dot gel layer.
